(19) United States
(12) Patent Application Publication
(10) Pub. No.: US 2011/0187216 A1
(43) Pub. Date: Aug. 4, 2011

(54) HYDRODYNAMIC DISC DRIVE SPINDLE MOTORS HAVING HYDRO BEARING WITH LUBRICANT INCLUDING CONDUCTIVITY INDUCING AGENT

(75) Inventor: Raquib Uddin Khan, Pleasanton, CA (US)

(73) Assignee: SEAGATE TECHNOLOGY LLC, Scotts Valley, CA (US)

(21) Appl. No.: 12/852,161

(22) Filed: Aug. 6, 2010

Related U.S. Application Data
(60) Provisional application No. 61/231,833, filed on Aug. 6, 2009.

(51) Int. Cl. H02K 7/08; C10M 135/10

(52) U.S. Cl. 310/90; 508/410; 508/417

(57) ABSTRACT

Disc drive spindle motor having hydro bearing including a stationary member; a rotatable member which is rotatable with respect to the stationary member; and a hydro bearing interconnecting the stationary member and the rotatable member and having working surfaces separated by a lubricating fluid, wherein the lubricating fluid includes at least one synthetic ester base fluid having a viscosity index of at least 110; from 10 to 5000 ppm of at least one conductivity inducing agent; from 0.01% to 5% by weight, based on the total weight of the lubricating fluid, of at least one antioxidant; and from 0.01% to 5% by weight, based on the total weight of the lubricating fluid, of at least one antiwear additive.

### PRIORITY

This application claims priority to U.S. Provisional Application No. 61/231,833, filed Aug. 6, 2009 entitled “HYDRODYNAMIC DISC DRIVE SPINDLE MOTOR HAVING HYDRO BEARING WITH LUBRICANT WITH CHARGE TRANSFER ABILITY”, the disclosure of which is incorporated herein by reference.

### SUMMARY

Disclosed spindle motors include a central axis; a stationary member; a rotatable member which is rotatable about the central axis with respect to the stationary member; and a hydro bearing interconnecting the stationary member and the rotatable member and having working surfaces separated by a lubricating fluid, wherein the lubricating fluid comprises: a) at least one synthetic ester base fluid having a viscosity index of at least 110; b) from 10 to 5000 ppm of at least one conductivity inducing agent; c) from 0.01% to 5% by weight, based on the total weight of the lubricating fluid, of at least one antioxidant; and d) from 0.01% to 5% by weight, based on the total weight of the lubricating fluid, of at least one antiwear additive.

A spindle motor that includes a stationary member; a rotatable member which is rotatable with respect to the stationary member; and a hydro bearing interconnecting the stationary member and the rotatable member and having working surfaces separated by a lubricating fluid, wherein the lubricating fluid includes: a synthetic ester base fluid having a viscosity index of at least 110; from 10 to 5000 ppm by weight, based on the total weight of the lubricating fluid, of one or more aryl sulfonic acid conductivity inducing agent; from 0.1% to 5%, by weight based on the total weight of the lubricating fluid, of at least one phenol antioxidant, amine antioxidant or phenol and amine antioxidants; and from 0.1% to 5% by weight, based on the total weight of the lubricating fluid, of at least one antiwear additive.

Also disclosed is a lubricating fluid that includes a synthetic ester base fluid having a viscosity index of at least 110; from 50 to 1000 ppm by weight, based on the total weight of the lubricating fluid, of one or more aryl sulfonic acid conductivity inducing agents; from 0.01% to 5%, by weight based on the total weight of the lubricating fluid, of at least one phenol antioxidant, amine antioxidant or phenol and amine antioxidants; and from 0.01% to 5% by weight, based on the total weight of the lubricating fluid, of at least one antiwear additive.

These and various other features and advantages will be apparent from a reading of the following detailed description.

### BRIEF DESCRIPTION OF THE DRAWINGS

The disclosure may be more completely understood in consideration of the following detailed description of various embodiments of the disclosure in connection with the accompanying drawings, in which:

FIG. 1 is a top plan view of a disc drive data storage device comprising a hydrodynamic or hydrostatic bearing spindle motor with a lubricating fluid.

FIG. 2 is a sectional view of a hydrodynamic spindle motor.

FIG. 3 is a diagrammatic sectional view of the hydrodynamic spindle motor taken along line 3-3 of FIG. 2, with portions removed for clarity.

FIG. 4 is a graph showing the conductivity at various temperatures for a comparative composition and two compositions as disclosed in Example 1.

FIG. 5 is a graph showing the conductivity at various temperatures for a comparative composition and a composition as disclosed in Example 1.

FIG. 6 is a graph showing the % remaining oil for a comparative composition and a composition as disclosed in Example 2.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following description, reference is made to the accompanying set of drawings that form a part hereof and in which are shown by way of illustration several specific embodiments. It is to be understood that other embodiments are contemplated and may be made without departing from the scope or spirit of the present disclosure. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

“Include,” “including,” or like terms such as “comprise” or “comprising” means encompassing but not limited to, that is, including and not exclusive.

As used herein the expression “synthetic ester” refers to any ester compound suitable to be employed in a base fluid (also designated in the art as functional fluid or working fluid) of a lubricant.

The expression “synthetic ester base fluid” as used herein collectively refers to any and all synthetic esters employed in formulating a lubricating fluid. The expression, therefore, may designate a single synthetic ester, or a combination of two or more synthetic esters, depending on whether the synthetic ester component of the lubricating fluid consists of a single ester or of a combination of two or more synthetic esters.

The expression “viscosity index” or “VI” as used herein refers to an artificially created index indicating the change of kinematic viscosity of a base fluid with temperature as set up by the Society of Automotive Engineers (SAE). Unless indicated otherwise, the temperatures chosen for reference are 100° Fahrenheit (F) (40° C.) and 210° F. (100° C.).

Unless specifically stated otherwise, the expression “hydrocarbon” designates a moiety consisting of carbon and hydrogen atoms which may be straight chain or branched and may be, or may comprise, one or more cyclic group(s). In general and unless specifically stated otherwise, the hydrocarbon group may be saturated, partially unsaturated or aromatic, and may comprise sub-moieties which are saturated, partially unsaturated or aromatic. In general and unless specifically stated otherwise, a saturated straight-chain hydrocarbon moiety or sub-moiety, also referred to as “alkyl,” can have from 1 to about 20 carbon atoms, whereas a saturated and branched hydrocarbon moiety or sub-moiety, also referred to as “alkyl,” a saturated or partially unsaturated cyclic hydrocarbon moiety or submoiety, also referred to as “cyclically” and “cycloalkenyl,” respectively, and a partially unsaturated straight-chain or branched hydrocarbon moiety or sub-moiety, also referred to as “alkenyl” or “alkynyl,” can have from about 3 to about 20 carbon atoms. In general and unless specifically stated otherwise, an aromatic hydrocarbon moiety or sub-moiety, also referred to as “aryl,” can have from about 6 to about 18, i.e., 6, 10, 14 or 18, carbon atoms.

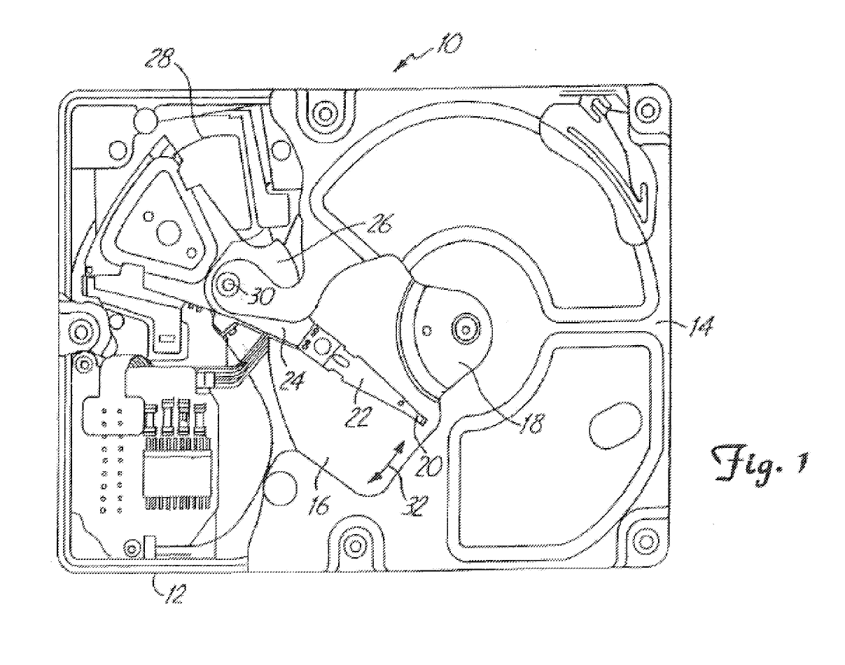

A hydrodynamic or hydrostatic bearing spindle motor including a disclosed lubricating fluid composition can be suited for a disc drive. FIG. 1 is a top plan view of a typical disc drive 10. Disc drive 10 includes a housing base 12 and a top cover 14. The housing base 12 is combined with top cover 14 to form a sealed environment to protect the internal components from contamination by elements from outside the sealed environment.

Disc drive 10 further includes a disc pack 16 which is mounted for rotation on a spindle motor (not shown) by a disc clamp 18. Disc pack 16 includes a plurality of individual discs which are mounted for co-rotation about a central axis. Each disc surface has an associated head 20 which is mounted to disc drive 10 for communicating with the disc surface. In the example shown in FIG. 1, heads 20 are supported by flexures 22 which are in turn attached to head mounting arms 24 of an actuator body 26. The actuator shown in FIG. 1 is of the type known as a rotary moving coil actuator and includes a voice coil motor (VCM), shown generally at 28. Voice coil motor 28 rotates actuator body 26 with its attached heads 20 about a pivot shaft 30 to position heads 20 over a desired data track along an arcuate path 31. While a rotary actuator is shown in FIG. 1, the spindle motor, is also useful in disc drives having other types of actuators, such as linear actuators.

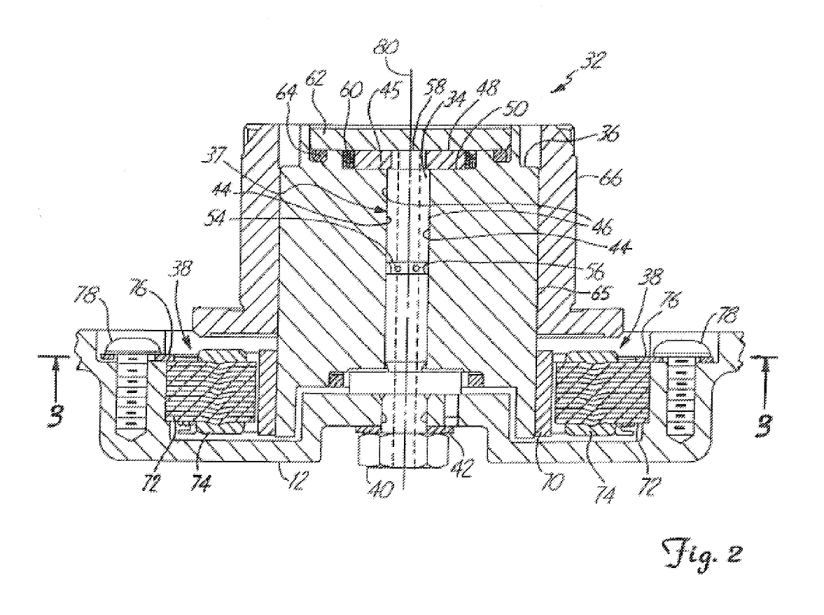

FIG. 2 is a sectional view of a hydrodynamic bearing spindle motor 32. Spindle motor 32 includes a stationary member 34, a hub 36 and a stator 38. In the embodiment shown in FIG. 2, the stationary member is a shaft which is fixed and attached to base 12 through a nut 40 and a washer 42. Hub 36 is interconnected with shaft 34 through a hydrodynamic bearing 37 for rotation about shaft 34. Bearing 37 includes radial working surfaces 44 and 46 and axial working surfaces 48 and 50. Shaft 34 includes fluid ports 54, 56 and 58 which supply lubricating fluid 60 and assist in circulating the fluid along the working surfaces of the bearing. Lubricating fluid 60 is supplied to shaft 34 by a fluid source (not shown) which is coupled to the interior of shaft 34 in a known manner.

Spindle motor 32 further includes a thrust bearing 45 which forms the axial working surfaces 48 and 50 of hydrodynamic bearing 37. A counterplate 62 bears against working surface 48 to provide axial stability for the hydrodynamic bearing and to position hub 36 within spindle motor 32. An O-ring 64 is provided between counterplate 62 and hub 36 to seal the hydrodynamic bearing. The seal prevents hydrodynamic fluid 60 from escaping between counterplate 62 and hub 36.

Hub 36 includes a central core 65 and a disc carrier member 66 which supports disc pack 16 (shown in FIG. 1) for rotation about shaft 34. Disc pack 16 is held on disc carrier member 66 by disc clamp 18 (also shown in FIG. 1). A permanent magnet 70 is attached to the outer diameter of hub 36, which acts as a rotor for spindle motor 32. Core 65 is formed of a magnetic material and acts as a back-iron for magnet 70. Rotor magnet 70 can be formed as a unitary, annular ring or can be formed of a plurality of individual magnets which are spaced about the periphery of hub 36. Rotor magnet 70 is magnetized-ho form one or more magnetic poles.

Stator 38 is attached to base 12 and includes stator laminations 72 and a stator windings 74. Stator windings 74 are attached to laminations 72. Stator windings 74 is spaced radially from rotor magnet 70 to allow rotor magnet 70 and hub 36 to rotate about a central axis 80. Stator 38 is attached to base 12 through a known method such as one or more C-clamps 76 which are secured to the base through bolts 78.

Commutation pulses applied to stator windings 74 generate a rotating magnetic field which communicates with rotor magnet 70 and causes hub 36 to rotate about central axis 80 on bearing 37. The commutation pulses are timed, polarization-selected DC current pulses which are directed to sequentially selected stator windings to drive the rotor magnet and control its speed.

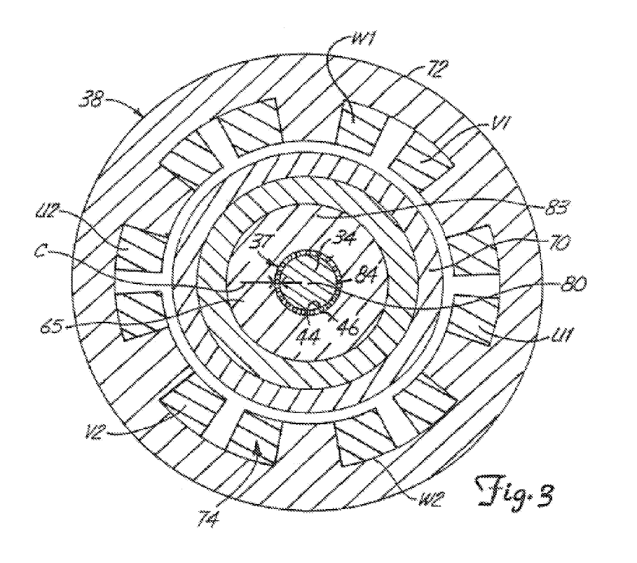

In the embodiment shown in FIG. 2, spindle motor 32 is a “below-hub” type motor in which stator 38 has an axial position that is below hub 36. Stator 38 also has a radial position that is external to hub 36, such that stator windings 74 are secured to an inner diameter surface 82 (FIG. 3) of laminations 72. In an alternative embodiment, the stator is positioned within the hub, as opposed to below the hub. The stator can have a radial position which is either internal to the hub or external to the hub. In addition, the spindle motor can have a fixed shaft, as shown in FIG. 2 or a rotating shaft. In a rotating shaft spindle motor, the bearing is located between the rotating shaft and an outer stationary sleeve which is coaxial with the rotating shaft.

FIG. 3 is a diagrammatic sectional view of hydrodynamic spindle motor 32 taken along line 3-3 of FIG. 2, with portions removed for clarity. Stator 38 includes laminations 72 and stator windings 74, which are coaxial with rotor magnet 70 and central core 65. Stator windings 74 include phase windings W1, V1, U1, W2, V2 and U2 which are wound around teeth in laminations 72. The phase windings are formed of coils which have a coil axis that is normal to and intersects central axis 80. For example, phase winding W1 has a coil axis 83 which is normal to central axis 80. Radial working surfaces 44 and 46 of hydrodynamic bearing 37 are formed by the outer diameter surface of shaft 34 and the inner diameter surface of central core 65. Radial working surfaces 44 and 46 are separated by a lubrication fluid 60, which maintains a clearance c during normal operation.

Synthetic Ester Base Fluids

Suitable synthetic ester base fluids in the context of the lubricating fluid in principle include all esters suitable as base oils for lubricating purposes. The synthetic ester base fluid may include a single synthetic ester or a combination of two or more synthetic esters of the same or of different type.

In embodiments, suitable synthetic ester base fluids can include esters of monoalcohols and monocarboxylic acids; di- and polyesters, such as those of di- or polyols and identical or different monocarboxylic acids; di- and polyesters of identical or different monoalcohols and identical or different di- or polybasic carboxylic acids; and polyesters of identical or different di- or polyols and identical or different di- or polybasic carboxylic acids.

In embodiments, the base fluid can exhibit a viscosity index of at least 110. In embodiments, synthetic ester base fluids having a high VI can be utilized. For dieters of dicarboxylic acids and polyol esters, for example, the VI typically ranges from about 115 or 120 respectively to 200.

In embodiments where the ester includes one or more moieties derived from monoalcohols, the monoalcohols can be saturated, aliphatic alcohols [e.g., of formula (CₙH_{2n/1})OH]. In embodiments, such alcohols can have from about 3 to about 20 carbon atoms. The hydrocarbon moiety of the alcohols can be saturated, and may be straight-chain or branched. The alcohol can form or include one or more saturated alicyclic moieties. Exemplary saturated, aliphatic alcohols can include 1-propanol, 1-butanol, 1-pentanol, 1-hexanol, 1-heptanol, 1-octanol (capryl alcohol), 1-nonanol (pelargonic alcohol), 1-decanol (capric alcohol), 1-undecanol, 1-dadecanol (lauryl alcohol), 1-tridecanol, 1-tetradecanol (myristyl alcohol), 1-pentadecanol, 1-hexadecanol (cetyl alcohol), 1-heptadecanol and the like, as well as their branched isomers in which the hydroxyl group is in the 2- or 3-position, and/or in which the hydrocarbon chain carries one or two methyl and/or ethyl branches. Illustrative specific examples of such branched aliphatic alcohols include iso-forms having a terminal CH(CH₃)₂ moiety and neo-forms comprising a C—C(CH₃)₂—C moiety. Also suitable are monoalcohols such as polyoxyalkylene ethers that can be represented by the formula R—O—(Z¹—O—)ₓH in which
R denotes a hydrocarbon which is straight-chain, branched or alicyclic and which may include alicyclic segments or substituents,
x is an integer, e.g., from 1 to 5, and
Z¹ represents identical or different C₂-C₄-alkylene groups such as 1,2-ethylene, 1,2-propylene, 1,3-propylene, 1,2-butylene, 2,3-butylene, 1,3-butylene, 1,4-butylene and the like.

Additionally, the (Z¹—O)ₓ group may represent a five or six-membered ring formed by one or two oxygen and 3, 4 or 5 carbon ring members. In the case of esters which comprise more than one moiety derived from a monoalcohol, the respective alcohol moieties may be identical or different.

Where the ester includes one or more moieties derived from di- and polyols, embodiments can utilize synthetic esters in which the di- or polyols are saturated, aliphatic alcohols [e.g., of formula (CₙH₂ₙ−x)(C(═O)OH)₂₊ₓ with x being 0 in the case of diols and x being ≧1, for example 1, 2 or 3, in the case of polyols] in particular having from about 3 to about 20 carbon atoms. In embodiments, hydroxyl groups of the di- and polyols are not bonded to the same carbon atom. The di- and polyols may be straight-chain or branched and may form or include one or more saturated alicyclic groups. Illustrative examples of saturated, ali-phatic diols include 1,3-propyleneglycol, 1,4-butyleneglycol, 1,5-pentyleneglycol, 1,6-hexyleneglycol, 1,7-heptyleneglycol, 1,8-octyleneglycol, 1,9-nonyleneglycol, 1,10-decyleneglycol, 1,11-undecyleneglycol, 1,12-dodecyleneglycol, 1,13-tridecylene-glycol, 1,14-tetradecyleneglycol, 1,15-pentadecyleneglycol, 1,16-hexadecyleneglycal, 1,17-heptadecyleneglycol and the like, as well as their branched isomers in which one or both of the hydroxyl groups is bonded to a non-terminal carbon atom of the alkylene chain, and/or in which the alkylene chain carries one or two methyl and/or ethyl branches bonded to any position along the alkylene chain. Also suitable are diols such as polyoxyalkylene glycols as represented by formula H—O—(Z¹—O—)ₓH in which x is an integer, e.g., from 1 to 5, and Z¹ represents identical or different C₂-C₄-alkylene groups such as 1,2-ethylene, 1,2-propylene, 1,3-propylene, 1,2-butylene, 2,3-butylene, 1,3-butylene, 1,4-butylene and the like. Additionally, the (Z¹—O)ₓ group may represent a five or six-membered ring formed by one or two oxygens and 3, 4 or 5 carbon ring members. Illustrative examples of saturated, aliphatic polyols include for example glycerine, trimethylol-propane and pentaerythritol. In the case of esters which include more than one moiety derived from a di- or polyol, the respective moieties may be identical or different.

Where the ester comprises one or more moieties derived from monocarboxylic acids, embodiments can utilize synthetic esters are preferred in which the monocarboxylic acids are saturated, aliphatic acids [e.g., of formula (CₙH_{2+1C})C(═O)OH], in particular acids having from about 3 to about 20 carbon atoms. The hydrocarbon moiety of such acids can be saturated, and may be straight-chain or branched and may form or include one or more saturated alicyclic groups. Representatives of saturated, aliphatic acids include propanoic acid, butanoic acid, pentanoic acid (valeric acid), hexanoic acid (caproic acid), heptanoic acid (enanthic acid), octanoic acid (caprylic acid), nonanoic acid (pelargonic alcohol), decanoic acid (capric acid), 1-undecanoic acid, dodecanoic acid (lauric acid), tridecanoic acid, tetradecanoic acid (myristic acid), pentadecanoic acid, hexadecanoic acid (palmitic acid), heptadecanoic acid, octadecanoic acid (stearic acid) and eicosanoic acid (arachidic acid), as well as their branched isomers in which the carboxyl group is in the 2- or 3-position, and/or in which the hydrocarbon moiety carries one or two. methyl and/or ethyl branches. Illustrative representatives of such branched aliphatic carboxylic acids include iso-forms having a terminal CH(CH₃)₂ moiety and neo-forms including a C—C(CH₃)₂—C moiety. In the case of esters which include more than one moiety derived from a monocarboxylic acid, the respective acid moieties may be identical or different.

Where the ester comprises one or more moieties derived from di- and polycarboxylic acids, embodiments can utilize synthetic esters in which the di- or polycarboxylic acids are saturated, aliphatic acids [e.g., of formula (CₙH₂ₙ₋ₓ)(C(═O)OH)₂₊ₓ with x being 0 in the case of dicarboxylic acids and x being ≧1, for example 1 or 2, in the case of polycarboxylic acids] for example those having from about 3 to about 20 carbon atoms. The di- and polycarboxylic acids may have straight-chain or branched hydrocarbon moieties and may form or include saturated alicyclic moieties. Illustrative examples of saturated, aliphatic dicarboxylic acids include 1,3-propanedioic acid (malonic acid), 1,4-butanedioic acid (succinic acid), 1,5-pentanedioic acid (glutaric acid), 1,6-hexanedioic acid (adipic acid), 1,7-heptanedioic acid (pimelic acid), 1,8-octanedioic acid (suberic acid), 1,9-nonanedioic acid (azelaic acid), 1,10-decanedioic acid (sebacic acid), 1,11-undecanedioic acid, 1,12-dodecanedioic acid, 1,13-tridecanedioic acid, 1,14-tetra-decanedioic acid, 1,15-pentadecanedioic acid, 1,16-hexadecanedioic acid, 1,17-heptadecanedioic acid and the like, as well as their branched isomers in which one or both of the carboxyl groups is bonded to a non-terminal carbon atom of the alkylene chain, and/or in which the alkylene chain carries one or two methyl and/or ethyl branches bonded to any position along the alkylene chain. Illustrative examples of saturated, aliphatic polycarboxylic acids include for example oxalmalonic acid, carballylic acid and the like. In the case of esters which include more than one moiety derived from a di- or polycarboxylic acid, the respective moieties may be identical or different.

In embodiments, the synthetic ester base fluid includes at least one synthetic ester selected from the group of diesters of dicarboxylic acids and full esters of diols.

In embodiments, the synthetic ester base fluid can include one or more esters of formula (I)

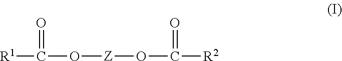

wherein R¹ and R² are identical or different and each represents a straight-chain C₃-C₁₇-alkyl group which optionally carries a C₁-C₃-alkyl branch bonded to a secondary carbon of the chain; and Z is a straight-chain C₃-C₁₀-alkylene group which optionally carries a C₁-C₃-alkyl branch bonded to a carbon of the chain.

In embodiments, the esters of formula (I) can include a total of from about 15 to about 35, from about 15 to about 33, from about 18 to about 30, or from about 18 to about 28, carbon atoms when all carbon atoms present in the longest straight-chain alkyl moiety of R¹ and of R², and all carbon atoms in the straight-chain alkylene moiety of Z are counted without including any carbon atoms of branches. With a view to the moiety Z this means that a moiety which is represented by formula —(CH₂)₂—CH(CH₃)—(CH₂)₂— contributes five carbon atoms, and a moiety which is represented by formula —CH₂—CH(CH₂CH₃)—CH₂— accounts for three carbon atoms. Accordingly, and as example only, a compound (I) in which each of R¹ and R² is an n-heptyl group and Z is a 1,5-pentylene group comprises a total of (7+7+5) 19 carbon atoms in the straight-chain moieties, and a compound (I) in which each of R¹ and R² is a 2-octanyl group (i.e., H₃C—(CH₂)₅—CH(CH₃)—) and Z is a 3-methyl-1,5-pentylene group (i.e., —(CH₂)₂—CH(CH₃)—(CH₂)₂—) also comprises a total of (7+7+5) 19 carbon atoms in the straight-chain moieties.

In embodiments, each of R¹ and R² includes a straight-chain hydrocarbon moiety having from about 6 to about 14 carbon atoms, which straight-chain hydrocarbon moiety optionally carries a methyl, ethyl, propyl or isopropyl branch, the branch being located such that the longest straight-chain hydrocarbon of the group R¹ or R² does not exceed about 14 carbon atoms.

In a further particular embodiment, each of R¹ and R² includes a straight-chain hydrocarbon moiety having from about 6 to about 14 carbon atoms, which straight-chain hydrocarbon moiety optionally carries a methyl or ethyl branch, the branch being located such that the longest straight-chain hydrocarbon of R¹ or of R does not exceed about 14 carbon atoms.

In embodiments, the sum of all branches which are present in R¹, R² and Z is 0, 1 or 2. According to this embodiment, if Z represents a moiety having two branches, each of R¹ and R² represents a straight-chain hydrocarbon group. Correspondingly, if Z represents a moiety having 1 branch, one of the hydrocarbons of R— and R² may carry one branch, or each of R¹ and R² represents a straight-chain hydrocarbon group. Similarly, if Z represents a moiety having no branch, one of the hydrocarbons of R¹ and R² may carry two branches, or one or both of the hydrocarbons of R¹ and R² may carry one branch, or each of R¹ and R² represents a straight-chain hydrocarbon group. In embodiments, the moiety Z carries 0 or 1 branch. In embodiments, each of R¹ and R² consists of a straight-chain hydrocarbon moiety having from about 6 to about 14 carbon atoms. In embodiments, R¹ and R² of the esters of formula (I) can be identical. In embodiments, the synthetic ester base fluid includes at least one ester of formula (I) in which R¹ and R² are independently from one another n-C₆-C₁₂-alkyl and Z is neopentylene (—CH₂—C(CH₃)₂—CH₂—), 1,5-pentylene(—(CH₂)₅—) or 3-methyl-1,5-pentylene (—(CH₂)₂—CH(CH₃)—(CH₂)₂—). In embodiments, the synthetic ester base fluid includes at least two different synthetic esters. In embodiments, the synthetic ester base fluid includes at least two different synthetic esters and at least one of the synthetic esters is of formula (I). In embodiments, the synthetic ester base fluid includes a synthetic ester selected from the group of 3-methyl-1,5-pentanediol di(n-hexanoate), 3-methyl-1,5-pentane-diol di(n-heptanoate), 3-methyl-1,5-pentanediol di(n-octanoate), 3-methyl-1,5-pentanediol di(n-nonanoate), and 3-methyl-1,5-pentanediol di(n-deaconate), 3-methyl-1,5-pentanediol di(n-undecanoate), 3-methyl-1,5-pentanediol di(n-dodecanoic), and 3-methyl-1,5-pentanediol di(n-tridecanoate), and combinations thereof.

In embodiments, the synthetic ester base fluid includes at least one synthetic ester selected from the group of a mixture of diesters prepared from 3-methyl-1,5-pentanedial and n-hexanoic acid arid n-heptanoic acid; a mixture of diesters prepared from 3-methyl-1,5-pentanediol and n-hexanoic acid and n-octanoic acid; a mixture of diesters prepared from 3-methyl-1,5-pentanediol and n-hexanoic acid and n-nonanoic acid; a mixture of diesters prepared from 3-methyl-1,5-pentanediol and n-hexanoic acid and n-decanoic acid; a mixture of diesters prepared from 3-methyl-1,5-pentanediol and n-heptanoic acid and n-octanoic acid; a mixture of diesters prepared from 3-methyl-1,5-pentanediol and n-heptanoic acid and n-nonanoic acid; a mixture of diesters prepared from 3-methyl-1,5-pentanediol and n-heptanoic acid and n-decanoic acid; a mixture of diesters prepared from 3-methyl-1,5-pentanediol and n-octanoic acid and n-nonanoic acid; and a mixture of diesters prepared from 3-methyl-1,5-pentanediol and n-octanoic acid and n-decanoic acid, or combinations of two or more of these synthetic ester mixtures.

In embodiments, the synthetic ester base fluid can include one or more esters of formula (Ia)

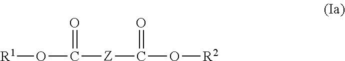

wherein R¹ and R² are identical or different and each represents a straight-chain C₃-C₁₇-alkyl group which optionally carries a C₁-C₃-alkyl branch bonded to a secondary carbon of the chain; and Z is a straight-chain C₃-C₁₀-alkylene group which optionally carries a C₁-C₃-alkyl branch bonded to a carbon of the chain. Compounds of formula Ia can more specifically have the same characteristics of compounds of formula I noted above.

In embodiments, the synthetic ester base fluid includes at least one synthetic ester selected from the group of esters of formula (I) or (Ia); esters of straight-chain C₅-C₁₂-dicarboxylic acids as mentioned above with (straight-chain or branched chain) C₆-C₁₃-alcohols, such as dioctyl sebacate (for example, 2-ethylhexyl sebacate), dioctyl adipate, dioctyl azelate, and the like; esters of straight-chain C₅-C₁₂ monocarboxylic acids as mentioned above with C₆-C₁₃ dialcohols (either straight or branched chain) (for example 3-methyl 1,5-pentanediol dihexanoate or 3-methyl 1,5-pentane diol dinonanoate); esters of trimethylolpropane; and esters of neopentylglycol.

Conductivity Inducing Agent

Disclosed lubricating compositions also include at least one conductivity inducing agent. Conductivity inducing agents can also be referred to as antistatic agents. Conductivity inducing agents can have conductivity inducing properties, antistatic properties, or both. Conductivity inducing agents can include all non-metallic compounds which are capable of inducing conductivity to a lubricating fluid or which are capable of preventing the build-up of static charges. Non-metallic as used herein is intended to exclude all metals and metal particles which, due to their particulate nature, may interfere with the proper functioning of a spindle motor. Compounds which comprise metal, e.g., in the form of ions or in complexed form, however, are understood to be non-metallic.

In embodiments, a lubricating fluid that includes a conductivity inducing agent can afford a lubricating fluid that is conductive but does not break down at high temperatures. In embodiments, a disclosed lubricating fluid can be resistant at temperatures at or above 50° C. In embodiments, a disclosed lubricating fluid can be resistant at temperatures at or above 100° C. In embodiments, a disclosed lubricating fluid can be resistant at temperatures at or above 120° C. In embodiments, a disclosed lubricating fluid can be resistant at temperatures at or above 150° C. Such a lubricating fluid has advantages over other lubricating fluids which can break down at high temperatures. Breakdown of a lubricating fluid at high temperatures can be shown by changes in the evaporation rates or amounts of lubricating fluid that evaporates over time at given temperature when compared to a lubricating fluid without a particular additive.

Conductivity inducing agents can include for examples compounds and compositions such as those described below: a.) mixtures of chromium dialkyl salicylate and calcium didecyl sulfosuccinate in copolymers of lauryl methacrylate and methyl vinyl pyridine can be utilized. Specific examples include ASA-3 (Royal Lubricants Company, Inc., East Hanover, N.J.). The primary dissociating constituent of such mixtures is the chromium dialkyl salicylate, which can be stabilized by calcium didecyl sulfosuccinate; b.) compositions (in aromatic solvents for example) of a polymeric condensation product of N-tallow-1,3-diaminopropane and epichlorohydrin (3). A specific example includes Polyfloe 130; c.) compositions of 1-decene polysulfone and dicocodimethylammonium nitrite in toluene; d.) colloidal solutions of alkylsalicylates, sulfonates, succinimides and other polar additives; e.) magnesium oleate, the calcium salt of nitrate lube oil with stearic acid, compositions of chromium salts of C₁₇-C₂₀-synthetic fatty acids in toluene, chromium stearate, chromium salt long chain acids, chromium oleate, chromium linoleate, cobalt naphthenate, copper naphthenate, nickel naphthenate, diethylamine, 2-methylpyridine, pyridine, 3-methylpyridine, 2-amino-5-nitropyridine, and 2,6-dinitro-3-chloropyridine; f.) stearylanthranylic which can be commercially obtained as Sigbol, ASP-1, or Kerostat for example; g.) conducting polyaniline derivatives made soluble with long chain organic acid or hydrocarbon side chains; and h.) metal ion containing fullerenes (C₆₀₊ₙM, where n is 0, 1, etc. and M is La) or any metal ion capable of electron transfer.

In embodiments, a conductivity inducing agent can include at least one polymeric compound. In embodiments, a conductivity inducing agent can include at least one polymeric compound that contains nitrogen (N). In embodiments, a conductivity inducing agent can include at least one polyaniline. In embodiments, a conductivity inducing agent can include at least one polyaniline comprising polymer unit represented by formula I:

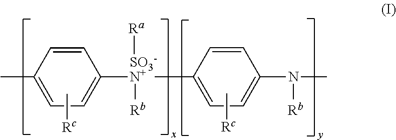

wherein 0<x/y<1, and R^{a}, R^{b}, and R^{c} are each independently hydrogen or a hydrocarbon group. Additionally, R^{c} may represent one or more halogen atoms or a hydrocarbon group which are bonded to the phenyl ring via oxygen or sulfur, e.g., alkoxy and alkylthio and the like, cyclic and optionally aromatic groups.

The nature of the hydrocarbon groups in the polyaniline comprising polymer of formula I can be such that the lipophilic character of the polymer is sufficient for it to mix with the lubricating fluid. In embodiments it can dissolve in the lubricating fluid. As such, each of the hydrocarbon substituents may specifically represent one of the following: a.) straight chain or branched alkyls, which can be optionally substituted by one or more halogen, (mono- or poly)cycloalkyl or aryl groups which can be substituted (e.g., by one or more halogen, alkyl, (mono- or poly)cycloalkyl, or aryl); b.) (mono- or poly)cycloalkyl, i.e., cycloalkyl which may be mono- or polycyclic and that can optionally be substituted by one or more halogen, alkyl, (mono- or poly)cycloalkyl, or aryl groups, wherein each alky group in turn may be substituted, e.g., by one or more halogen, cycloalkyl, or aryl groups, and each of the cyclic groups, in turn may be substituted, e.g., by one or more halogen, alkyl, (mono- or poly)cycloalkyl, or aryl; c.) aryl which may be mono- or polycyclic such as phenyl, naphthyl, and anthracenyl, which is optionally substituted by one or more halogen, alkyl, (mono- or poly)cycloalkyl, or aryl groups, wherein each alkyl group in turn may be substituted by one or more halogen, (mono- or poly)cycloalkyl, or aryl groups, and each of the cyclic groups, in turn may be substituted, e.g., by one or more halogen, alkyl, (mono- or poly)cycloalkyl and aryl.

In embodiments, the conductivity inducing agent can include at least one sulfonic acid R^{a}—SO₃H, or a salt thereof, wherein R^{a} is as defined above. Suitable sulfonic acids can include all sulfonic acids and salts thereof which can convey electrical conductivity to the lubricating fluid, or which can reduce the build-up of static charges. Generally, the hydrocarbon group has at least 6, at least 8, or at least 10 carbon atoms. In embodiments, R^{a} in the sulfonic acid can be an aryl group, or include at least one aryl group. Such an aryl group(s) can have from 6 to 14 carbon atoms. For example, phenyl, naphthyl, anthracenyl and the like. The sulfonic acid moiety can be directly bonded to one of the aryl carbon atoms or can be linked to the aryl carbon via a methylene (—CH₂—) bridge. Moreover, the aryl group(s) may carry from one to three halogen, or hydrocarbon substituents. In embodiments, the aryl sulfonic acid can be a C₆-C₂₀-alkyl-C₆-C₁₄-aryl sulfonic acid which can optionally be further substituted by halogen(s).

Specific illustrative examples of such aryl sulfonic acids can include for example phenylsulfonic acids in which the phenyl ring optionally carries one, two or three identical or different straight chain or branched chain C₆-C₂₀-alkyl groups such as straight or branched hexyl-phenyl sulfonic acid; straight or branched heptyl-phenyl sulfonic acid; straight or branched octyl-phenyl sulfonic acid; straight or branched nonyl-phenyl sulfonic acid; straight or branched decyl-phenyl sulfonic acid; straight or branched undecyl-phenyl sulfonic acid; straight or branched dodecyl-phenyl sulfonic acid (or dodecylbenzene sulfonic acid); straight or branched tridecyl-phenyl sulfonic acid; straight or branched tetradecyl-phenyl sulfonic acid; straight or branched pentadecyl-phenyl sulfonic acid; straight or branched hexadecyl-phenyl sulfonic acid; straight or branched heptadecyl-phenyl sulfonic acid; straight or branched octadecyl-phenyl sulfonic acid; straight or branched nonadecyl-phenyl sulfonic acid; straight or branched decadecyl-phenyl sulfonic acid; straight or branched mono- or dihexyl-naphthyl sulfonic acid; straight or branched mono- or diheptyl-naphthyl sulfonic acid; straight or branched mono- or dioctyl-naphthyl sulfonic acid; straight or branched mono- or dinonyl-naphthyl sulfonic acid; straight or branched mono- or didecyl-naphthyl sulfonic acid; straight or branched mono- or diundecyl-naphthyl sulfonic acid; straight or branched mono- or didodecyl-naphthyl sulfonic acid; straight or branched mono- or ditridecyl-naphthyl sulfonic acid; straight or branched mono- or ditetradecyl-naphthyl sulfonic acid; straight or branched mono- or dipentadecyl-naphthyl sulfonic acid; straight or branched mono- or dihexadecyl-naphthyl sulfonic acid; straight or branched mono- or diheptadecyl-naphthyl sulfonic acid; straight or branched mono- or dioctadecyl-naphthyl sulfonic acid; straight or branched mono- or dinonadecyl-naphthyl sulfonic acid; or straight or branched mono- or didecadecyl-naphthyl sulfonic acid.

Illustrative commercially available examples of conductivity inducing agents include STAT-SAFE® 2500 (a combination of kerosene, o-xylene, dodecylbenzensulfonic acid, and solvent naphtha, commercially available from Innospec Specialty Chemicals, Chelshire, UK); EXPINN® 10 (a combination of heptane and dodecylbenzenesulfonic acid, commercially available from Innospec Specialty Chemicals, Chelshire, UK), STADIS® 450 (dinonyl napthyl sulfonic acid, commercially available from The Associated Octel Company Limited, Chelshire, UK); and STADIS® 425 (commercially available from The Associated Octel Company Limited, Chelshire, UK).

A lubricating fluid may include a single conductivity inducing agent or a combination of two or more conductivity inducing agents of the same or different types. The concentration of the conductivity inducing agent(s) in the lubricating fluid can vary widely. In embodiments, the concentration is kept relatively low so that the overall viscosity of the lubricating fluid is not affected. In embodiments, the concentration of the conductivity inducing agent can be from 10 to 5000 ppm, from 100 to 5000 ppm, from 50 to 1000 ppm, or from 50 to 500 ppm, in the lubricating fluid. In embodiments, disclosed lubricating fluids can have a resistance of less than 50 MΩ. For example, 1000 ppm (i.e., 0.1%) of aryl sulfonic acid(s) in a mineral based hydrocarbon has been found to provide suitable performance. This is a much lower concentration than typical ferrofluid lubricants in which the ferromagnetic particles have a concentration in the lubricant of up to 4%.

Further Additives

The lubricating fluid may optionally include effective amounts of one or more additives such as antioxidants, corrosion inhibitors, viscosity index modifiers, pour point depressants, anti-foaming agents, metal detergents and electrically conductive, non-metallic additives.

Suitable antioxidants can include all compounds which can suppress, prevent or diminish the oxidation of the lubricating fluid and/or the working surfaces of the spindle motor, such as amine-based antioxidants, phenol-based antioxidants, di(n-dodecyl)thiodipropionate, di(n-octadecyl)thiodipropionate and the like thiodipropionates, phenothiazine and the like sulfur-based compounds, etc.

In embodiments, the lubricating fluid can include at least one amine-based antioxidant or a combination of two or more amine-based antioxidants. Any amine-based antioxidants can be utilized. In embodiments, the amine-based antioxidant can be a compound which contains no sulfur in the molecule, and has from about 6 to 60, or from about 10 to 40, carbon atoms. In embodiments, the amine-based antioxidant can be selected from the group consisting of diaryl amines wherein the aryl groups are identical or different and each can be C₆-C₁₄-aryl which optionally carries one, two or three identical or different substituents selected from the group consisting of halogen and C₁-C₁₂-alkyl groups. In embodiments, the amine-based antioxidant can be selected from the group consisting of diaryl amines wherein the aryl groups are identical or different and each can be C₆-C₁₄-aryl which optionally carries one, two or three identical or different C₃-C₁₂-alkyl substituents.

Illustrative examples can include diphenylamines such as diphenylamine, monobutyl (including linear and branched) diphenylamines, monopentyl (including linear and branched) diphenylamines, monohexyl (including linear and branched) diphenylamines, monobutyl (including linear and branched) diphenylamines, monopentyl (including linear and branched) diphenylamines and like monoalkyl diphenylamines, in particular, mono(C₄-C₉-alkyl)diphenylamines (i.e., diphenylamines wherein one of the two benzene rings is mono-substituted with an alkyl group, in particular, a C₄-C₉-alkyl group, i.e., a monoalkyl-substituted diphenylamines); p,p′-dibutyl (including linear and branched) diphenylamines, p,p′ -dipentyl (including linear and branched) diphenylamines, p,p′-dihexyl (including linear and branched) diphenylamines, p,p′-diheptyl (including linear and branched) diphenylamines, p,p′-dioctyl (including linear and branched) diphenylamines, p,p′-dinonyl (including linear and branched) diphenylamines and like di(alkylphenyl)amines, in particular, p,p′-di(C₄-C₉-alkylphenyl)amines (i.e., dialkyl substituted diphenylamines wherein each of the benzene rings is mono-substituted with an alkyl group, in particular, a C₄-C₉-alkyl group, and the two alkyl groups are identical); di(mono C₄-C₉-alkylphenyl)amines wherein the alkyl group on one of the benzene rings is different from the alkyl group on the other of the benzene rings; di(di-C₄-C₉-alkylphenyl)amines wherein at least one of the four alkyl groups of the two benzene rings is different from the rest of the alkyl groups; naphthylamines such as N-phenyl-1-naph-thylamine, N-phenyl-2-naphthylamine, 4-octylphenyl-1-naphthylamine, 4-octylphenyl-2-naphthylamine and the like; phenylene-diamines such as p-phenylenediamine, N-phenyl-N′-isopropyl-p-phenylenediamine, N-phenyl-N′-(1,3-dimethylbutyl)-p-phenylenediamine and the like. In embodiments, p,p′-dioctyl (including linear and branched) diphenylamine, p,p′-dinonyl (including linear and branched) diphenylamine, and N-phenyl-1-naphthylamine can be utilized.

In embodiments, the lubricating fluid can include at least two different types of antioxidants. In embodiments, the lubricating fluid can include at least one amine-based antioxidant and at least one further antioxidant which is of a different type. In embodiments, the lubricating fluid can include at least one amine-based antioxidant and at least one phenol-based antioxidant. In embodiments a single phenol based antioxidant or two or more can be utilized. In embodiments, any phenol-based antioxidant can be utilized. In embodiments, a phenol-based antioxidant can be a compound which contains no sulfur atoms in the molecule. In embodiments, phenol-based antioxidants can have from about 6 to 100 carbon atoms, or from about 10 to 80 carbon atoms.

In embodiments, the phenol-based antioxidant can be selected from 2,6-di-t-butylphenol, 2,6-di-t-butyl-p-cresol, 4,4′-methylenebis(2,6-di-t-butylphenol), 4,4′-butylidene bis(3-methyl-6-t-butylphenol), 2,2′-methylenebis(4-ethyl-6-t-bu-tylphenol), 2,2′-methylenebis(4-methyl-6-t-butylphenol), 4,4′-isopropylidenebisphenol, 2,4-dimethyl-6-t-butylphenol, tetrakis[methylene-3-(3,5-di-t-butyl-4-hydroxyphenyl)-propionate]methane, 1,1,3-tris(2-methyl-4-hydroxy-5-t-butylphenyl)butane, 1,3, 5-trimethyl-2,4,6-tris (3,5-di-t-butyl-4-hydroxybenzyl)-benzene, 2,6-di-t-butyl-4-ethylphenol, bis[2-(2-hy-droxy-5-methyl-3-t-butylbenzyl)-4-methyl-6-t-butylphenyl]terephthalate, triethylene glycol bis[3-(3-t-butyl-5-methyl-4-hy-droxyphenyl)propionate], and 1,6-hexanediol-bis[3-(3,5-di-t-butyl-4-hydroxyphenyl)propionate] for example.

In embodiments, the phenol-based antioxidant can be selected from 2,6-di-t-butyl-p-cresol, 4,4′-methylene bis(2, 6-di-t-butylphenol), 2,6-di-t-butyl-4-ethylphenol, or combinations thereof.

In embodiments where the lubricating fluid includes a combination of one or more phenol-based antioxidants and one or more amine-based antioxidants, the ratio of phenol-based antioxidant(s) to amine-based antioxidant(s) can be suitably selected from a wide range, and the weight ratio of the phenol-based antioxidant (PBA) to the amine-based antioxidant (ABA) can be at least about 1 (PBA) to 0.05 (ABA) and up to 1 (PBA) to 20 (ABA). In embodiments, the ratio may be from at least about 1 (PBA) to 0.2 (ABA) and up to 1 (PBA) to 5 (ABA).

Illustrative embodiments of antioxidant combinations including at least one amine-based antioxidant and at least one phenol based antioxidant include: one or more members selected from the group consisting of 2,6-di-t-butyl-p-cresol, 4,4′-methylenebis (2,6-di-t-butyl-phenol), and 2,6-di-t-butyl-4-ethylphenol, one or more members selected from the group consisting of p,p′-dioctyl (including linear and branched) diphenylamine, p,p′-dinonyl (including linear and branched) diphenylamine and N-phenyl-1-naphthylamine; and combinations thereof.

In embodiments, the lubricating fluid can include one or more of the following combinations: 2,6-di-t-butyl-p-cresol and p,p′-dioctyl (including linear and branched) diphenylamine; 2,6-di-t-butyl-p-cresol and p,p′-dinonyl (including linear and branched) diphenylamine; 2,6-di-t-butyl-p-cresol and N-phenyl-1-naphthylamine, -4,4′-methylenebis(2,6-di-t-butylphenol) and p,p′-dioctyl (including linear and branched) diphenylamine; 4,4′-methylenebis(2,6-di-t-butylphenol) and p,p′-dinonyl (including linear and branched) diphenylamine; 4,4′-methylenebis (2,6-di-t-butylphenol) and N-phenyl-1-naphthylamine; 2,6-di-t-butyl-4-ethylphenol and p,p′-dioctyl (including linear and branched) diphenylamine; 2,6-di-t-butyl-4-ethylphenol and p,p′-dinonyl (including linear and branched) diphenylamine; and 2,6-di-t-butyl-4-ethylphenol and N-phenyl-1-naphthylamine.

In embodiments, the lubricating fluid can include one or more of the following combinations: 4,4′-methylenebis(2,6-di-t-butylphenol) and p,p′-dioctyl (including linear and -branched) diphenylamine; 4,4′-methylenebis(2,6-di-t-butylphenol) and p,p′-dinonyl (including linear and branched) diphenylamine, and 4,4′-methylenebis(2,6-di-t-butylphenol) and N-phenyl-1-naphthylamine.

The total amount of antioxidant(s) present in a lubricating fluid can vary broadly. In general, the antioxidant(s) is (are) employed in a total amount which can be effective to prevent, suppress or sufficiently inhibit oxidative deterioration of the constituents of the lubricating fluid. Effective amounts may range from 0.01 to 5.0%, from 0.1% to 5.0%, from 0.05 to 5%, or from 0.1 to 3% based on the total weight of the lubricating fluid. The antioxidant(s) may be added in larger amounts. However, larger amounts generally do not further improve the suitability of tile lubricating fluid for spindle motors and may therefore be uneconomical. The antioxidant(s) may also be added in smaller amounts so long as the amounts are effective to prevent, suppress or sufficiently inhibit an oxidative deterioration of the constituents of the lubricating fluid.

The lubricating fluid can also optionally include an additive for improving anti-wear properties, high pressure metal contact properties and friction properties, i.e., an antiwear additive. Additives of this type can include, for example, dialkyl dithiophosphates, alkyl and aryl disulfides and polysulfides, dithiocarbamates, salts of alkylphosphoric acids, molybdenum complexes, neutral phosphate esters, and combinations of two or more of these additives. In embodiments, antiwear additives can include for example zinc dialkyl dithiophosphate, molybdenum disulphides, liquid amine phosphates, e.g., amine salts of an acid phosophate such as C₁₁-C₁₄ branched alkyl phosphates, monohexyl phosphate, dihexyl phosphate, dibutyl phosphate, dioctyl phosphate or dicresyl phosphate, amine salts of an acid phosphate such as dibutyl phosphate or diisopropyl phosphate, and neutral aryl phosphate esters. Exemplary liquid amine phosphates can be commercially obtained from Ciba Geigy.

Suitable neutral phosphate esters can include all phosphate triesters (also known as phosphoric acid triesters) (O═)P(OR)₃ wherein the substitutents “R” represent indentical or different hydrocarbon radicals. The hydrocarbon radicals generally have from 1 to 30, or from 4 to 18, carbon atoms and may be, or comprise, straight-chain or branched alkyl, cycloalkyl and aryl moities. Moreover, the hydrocarbon radicals may carry one or more halogen substitutents. Where present, the halogen substituents can be fluorine, chlorine, or bromine substituents for example.

In general, each of the substitutents, R, can independently represent: a.) straight chain or branched C₁-C₁₈-alkyl, which can be optionally substituted by one or more halogen, C₃-C₁₀-cycloalkyl, or C₆-C₁₄-aryl groups, and wherein the cyclic groups, in turn, may carry from 1 to 3 substituents selected from the group of halogen, C₁-C₁₀-alkyl, C₃-C₁₀-cycloalkyl and C₆-C₁₄-aryl; b.) C₃-C₁₀-cycloalkyl which may be mono- or polycyclic and which can be optionally substituted by one or more halogen, C₁-C₁₀-alkyl, C₃-C₁₀-cycloalkyl and C₆-C₁₄-aryl groups, wherein each alkyl group in turn may be substituted by one or more halogen, C₃-C₁₀-cycloalkyl, or C₆-C₁₄-aryl groups, and each of the cyclic groups, in turn, may carry from 1 to 3 substituents selected from the group of halogen, C₁-C₁₀-alkyl, C₃-C₁₀-cycloaklyl and C₆-C₁₄-aryl; c.) C₆-C₁₄-aryl which may be mono- or polycyclic such as phenyl, naphthyl and anthracenyl, which can be optionally substituted by one or more halogen, C₁-C₁₀-alkyl, C₃-C₁₀-(bocycloalkyl, or C₆-C₁₄-aryl groups, wherein each alkyl group in turn may be substituted by one or more halogen, C₃-C₁₀-cycloalkyl, or C₆-C₁₄-aryl groups, and each of the cyclic groups, in turn, may carry from 1 to 3 substituents selected from the group of halogen, C₁-C₁₀-alkyl, C₃-C₁₀-cycloaklyl, or C₆-C₁₄-aryl groups.

Examples of phosphoric acid triesters can include tributyl (including linear and branched) phosphate, tripentyl (including linear and branched) phosphate, trihexyl (including linear and branched) phosphate, tripheptyl (including linear and branched) phosphate, trioctyl (including linear and branched) phosphate, trinonyl (including linear and branched) phosphate, tridecyl (including linear and branched) phosphate, triundecyl (including linear and branched) phosphate, tridodecyl (including linear and branched) phosphate, tritridecyl (including linear and branched) phosphate, tritetradecyl (including linear and branched) phosphate, tripentadecyl (including linear and branched) phosphate, trihexadecyl (including linear and branched) phosphate, tripheptadecyl (including linear and branched) phosphate, trioctadecyl (including linear and branched) phosphates and like tri(linear or branched C₄-C₁₈-alkyl) phosphates having identical or different alkyl groups; tricyclopropyl phosphate, tricyclobutyl phosphate, tricyclpentyl phosphate, tricyclhexyl phosphate, tricoheptyl phosphate, tricycloctyl phosphate and like tri(C₃-C₈-cycloalkyl) phosphates, as well as corresponding phosphates in which one or two of the groups R represent(s) C₄-C₁₈-alkyl and the other group(s) R represent(s) C₃-C₈-cycloalkyl; triphenyl phosphate, tricresyl phosphate, trixylenyl phosphate, cresyldiphenyl phosphate, xylenyldiphenyl phosphate, tris(tribromophenyl) phosphate, tris(dibromopohenyl) phosphate, tris(2,4-di-t-butylphenyl) phosphate, tri(nonylphenyl) phosphate and like triaryl phosphates, as well as corresponding phosphates in which one or two of the groups R represent(s) C₄-C₁₈-alkyl and the other group(s) R represent(s) aryl, and also corresponding phosphates in which a first group R represents C₄-C₁₈-allkyl, a second group R represents C₃-C₈-cycloalkyl and the third group R represents aryl.

In embodiments, the neutral phosphate ester can be a triaryl phosphate. In embodiments, the neutral phosphate ester can be a tri-C₆-C₁₄-aryl phosphate wherein each of the aryl groups optionally carries from 1 to 3 identical or different substituents selected from halogen and C₁-C₁₂-alkyl groups. In embodiments, the neutral phosphate ester can be a tri-C₆-C₁₄-aryl phosphate wherein each of the aryl groups optionally carries from 1 to 3 identical or different C1-C12 alkyl groups. In embodiments, the neutral phosphate ester can be a tri-C6-C10-aryl phosphate wherein each of the aryl groups optionally carries from 1 to 3 identical or different C1-C8-alkyl groups. In embodiments, the neutral phosphate ester can be a tri C6-C10-aryl phosphate wherein each of the aryl groups carries at least one C1-C8-alkyl groups. In embodiments, the neutral phosphate ester can be a triphenyl phosphate wherein each of the phenyl rings optionally carried from 1 to 3 identical or different substituents selected from halogen and C1-C12-alkyl groups. In embodiments, the neutral phosphate ester can be a triphenyl phosphate wherein each of the phenyl rings optionally carried from 1 to 3 identical or different C1-C12-alkyl groups. In embodiments, the neutral phosphate ester can be a triphenyl phosphate wherein each of the phenyl rings optionally carried from 1 to 3 identical or different C1-C8-alkyl groups. In embodiments, the neutral phosphate ester can be a triphenyl phosphate wherein each of the phenyl rings carries at least one C1-C8-alkyl groups. In embodiments, the neutral phosphate ester can be a triphenyl phosphate wherein each of the phenyl rings carries at least one C3-C6-alkyl groups. In embodiments, the neutral phosphate ester can be triphenyl phosphate wherein each of the phenyl rings carried at least one straight chain or branched butyl group.

The lubricating fluid may include a single neutral phosphate ester or a combination of two or more neutral phosphate esters. Moreover, the lubricating fluid may include a single antiwear additive or a combination of two or more antiwear additives of similar or different types. The total amount of antiwear additives present in the lubricating fluid can vary widely. In general, the antiwear additive(s) can be employed in a total amount which is effective to prevent direct contact, e.g., metal to metal contact, of the working surfaces. Effective amounts normally range from 0.01 to 5% by weight, or from 0.05to 5%, or from 0.1% to 5%, or from 0.1 to 3% by weight, based on the total weight of the lubricating fluid. The antiwear additive(s) may be added in larger amounts. However, larger amounts generally do not further improve the suitability of the lubricating fluid for spindle motors and may therefore be uneconomical.

Lubricating fluids may also optionally include corrosion inhibitors. Suitable corrosion inhibitors (metal detergents, metal passivators, rust inhibitors) can include compounds which suppress, prevent or diminish corrosion of the working surfaces of the spindle motor, such as sulfonates, hydrocarbyl amines, carboxylic acid derivatives, imidazolines, thia(dia)zoles, (benzo)triazoles and amine phosphates.

In embodiments, the lubricating fluid can include at least one natural or synthetic sulfate that includes a hydrocarbon group having at least 9 carbon atoms, or a salt thereof. In embodiments, the lubricating fluid can include at least one salt of a natural or synthetic sulfate including a hydrocarbon group having at least 9 carbon atoms.

In embodiments, the lubricating fluid can include at least one Ca-petroleum sulfonate, over based Ca-petroleum sulfonate, Ca-alkylbenzene sulfonate, over based Ca-alkylbenzene sulfonate, Ba-alkylbenzene sulfonate, over based Ba-alkylbenzene sulfonate, Mg-alkylbenzene sulfonate, over based Mg-alkylbenzene sulfonate, Na-alkylbenzene sulfonate, over based Na-alkylbenzene sulfonate, Ca-alkylnaphthalene sulfonate, over based Ca-alkylnaphthalene sulfonate or like metal sulfonates; Ca-phenate, over based Ca-phenate, Ba-phenate, over based Ba-phenate or like metal phenates; Ca-salicylate, over based Ca-salicylate or like metal salicylates; Ca-phosphonate, over based Ca-phosphonate, Ba-phosphonate, over based Ba-phosphonate or like metal phosphonates; over based Ca-carboxylate, etc. In embodiments, the lubricating fluid can include at least one Ca-petroleum sulfonate, Ca-alkylbenzene sulfonate, Ba-alkylbenzene sulfonate, Mg-alkylbenzene sulfonate, Na-alkylbenzene sulfonate, Zn-alkylbenzene sulfonate, Ca-alkylnaphthalene sulfonate or like metal sulfonate.

In embodiments, the lubricating fluid can include at least one hydrocarbon substituted amine such as ethylamine, diethylamine, triethylamine, a primary, secondary or tertiary amine having one, two or three alkyl substituents each independently having from one to twenty carbon atoms, phenylene diamine, cyclohexylamine, morpholine, ethylene diamine, trie-thylene tetramine, tetraethylene pentamine and the like. In embodiments, the lubricating fluid can include at least one salt of a hydrocarbon substituted amine. In embodiments, the lubricating fluid can include at least one of rosin amine, N-oleyl sarcosine and like amines.

In embodiments, the lubricating fluid can include at least one carboxylic acid or carboxylic acid salt including a hydrocarbon group having at least 7 carbon atoms. In embodiments, the carboxylic acid or the salt thereof can include a hydrocarbon group having from 10 to 22 carbon atoms, or from 14 to 18 carbon atoms. Specific examples include n-dodecanoic acid, n-tridecanoic acid, n-tetradecanoic acid, n-pentadecanoic acid, n-hexadecanoic acid, n-heptadecanoic acid, n-octadecanoic acid, n-nonadecanoic acid, n-icosanoic acid, n-docosanoic acid, oleic acid, etc. In embodiments, n-tetradecanoic acid, n-hexadecanoic acid, and n-octadecanoic acid can be utilized. In embodiments, the lubricating fluid can include at least one dodecenylsuccinic acid half ester, octadecenylsuccinic anhydride, dodecenylsuccinic acid amide or like alkyl or alkenyl succinic acid derivative; sorbitan monooleate, glycerol monooleate, pentaerythritol monooleate or like partial esters of polyhydric alcohols.

In embodiments, the carboxylic acid derivative can be a gallic acid based compound. Examples of gallic acid-based compounds include those having 7 to 30 carbon atoms, or from 8 to 20 carbon atoms. Specific examples include gallic acid, methyl gallate, ethyl 10 gallate, propyl (including linear and branched) gallate, butyl (including linear and branched) gallate, pentyl (including linear and branched) gallate, hexyl (including linear and branched) gallate, heptyl (including linear and branched) gallate, octyl (including linear and branched) gallate, nonyl (including linear and branched) gallate, decyl (including linear and branched) gallate, undecyl (including linear and branched) gallate, dodecyl (including linear and branched) gallate, tridecyl (including linear and branched) gallate, tetradecyl (including linear and branched) gallate, pentadecyl (including linear and branched) gallate, hexadecyl (including linear and branched) gallate, heptadecyl (including linear and branched) gallate, octadecyl (including linear and branched) gallate, nonadecyl (including linear and branched) gallate, icosyl (including linear and branched) gallate, docosyl (including linear and branched) gallate and like linear or branched C₁-C₂₂-alkyl esters of gallic acid; and cyclohexyl gallate, cyclopentyl gallate and like C₄-C₈-cycloalkyl esters of gallic acid. In embodiments, (n-propyl) gallate, (n-octyl) gallate, (n-dodecyl) gallate and like linear or branched C₃-C₁₂-alkyl esters of gallic acid can be utilized.

In embodiments, the lubricating fluid can include at least one imidazole, thia (dia) zole- or (benzo)triazole-based compound that functions as a corrosion inhibitor. Essentially, any corrosion inhibiting imidazole, thia(dia)zole- or (benzo)triazole-based compound can be suitable. In embodiments, the corrosion inhibitor can be a triazole-based compound which has no sulfur in the molecule. In embodiments, the triazole-based compound can be a benzotriazole having from 6 to 60 carbon atoms, or from 6 to 40 carbon atoms for example. Illustrative examples include benzotriazole, 5-methyl-1H-benzo-triazole, 1-dioctylaminomethylbenzotriazole, 1-dioctylaminome-thyl-5-methylbenzotriazole, 2-(5′-methyl-2′-hydroxyphenyl)benzo triazole, 2-[2′-hydroxy-3′,5′-bis(α,α-dimethylbenzyl)phenyl]-2H-benzotriazole, 2-(3′,5′-di-t-butyl-2′-hydroxyphenyl)benzotriazole, 2-(3′-t-butyl-5′-methyl-2′-hydroxyphenyl)-5-chlorobenzotriazole, 2-(3,5′-di-t-butyl-2′-hydroxyphenyl)-5-chlorobenzotriazole, 2-(3′,5′-di-t-amyl-2′-hydroxyphenyl)benzotriazole, 2-(5′-t-bu-tyl-2′-hydroxyphenyl)benzotriazole, 2-(2-hydroxy-5′-methylphenyl)benzotriazole, 2-(2′-hydroxy-5′-t-octylphenyl)benzotriazole, 2-[2′-hydroxy-3′-(3″,4″-5″,6″ tetrahydrophthalideme-thyl)-5′-methylphenyl]benzotriazole, etc. In embodiments, the lubricating fluid can include benzotriazole and/or 5-methyl-1H-benzotriazole.

In general, the lubricating fluid may include a single corrosion inhibitor or a combination of two or more corrosion inhibitors of the same or of different type. The total amount of corrosion inhibitor(s) present in the lubricating fluid can vary broadly. In general, the corrosion inhibitor(s) can be employed in an amount(s) which can be effective to prevent, suppress or sufficiently inhibit corrosion of the working surfaces. Effective amounts may range from 0.01 to 5.0%, or from 0.05 to 5%, or from 0.1 to 3% by weight, based on the total weight of the lubricating fluid. The corrosion inhibitor(s) may be added in larger amounts. However, larger amounts generally do not further improve the suitability of the lubricating fluid for spindle motors and may therefore be uneconomical. The corrosion inhibitor(s) may also be added in smaller amounts so long as the amounts are effective to prevent, suppress or sufficiently inhibit the corrosion of the working surfaces of the spindle motor.

Disclosed lubricating fluids can also optionally include one or more viscosity index modifiers. Suitable viscosity index improvers (viscosity modifiers) can include all compounds which provide an increased viscosity at higher temperatures and a minimal viscosity contribution at lower temperatures, for example polymeric compounds. Examples of viscosity index improvers include polyalkylmethacrylates, polyalkylstyrenes, polybutenes, ethylene-propylene copolymers, styrene-diene copolymers, styrene-maleic anhydride ester copolymers, and like olefin copolymers. In general, a lubricating fluid may include a single viscosity index improver or a combination of two or more viscosity index improvers of the same or of different type.

The total amount of viscosity index improver(s) present in the lubricating fluid can vary broadly. In general, viscosity index improver(s) can be employed in amounts which can be effective to provide an increased viscosity at higher temperatures and a minimal viscosity contribution at low temperatures. Effective amounts may range from 0.01 to 5.0%, from 0.05 to 5%, or from 0.1 to 3% by weight, based on the total weight of the lubricating fluid. The viscosity index improver(s) may be added in larger amounts. However, larger amounts generally do not further improve the suitability of the lubricating fluid for spindle motors and may therefore be uneconomical. The viscosity index improver(s) may also be added in smaller amounts so long as the amounts are effective to provide an increased viscosity at higher temperatures and a minimal viscosity contribution at low temperatures.

Disclosed lubricating fluids can also optionally include pour point depressants. Suitable pour point depressants (low temperature flow improvers, wax crystal modifiers) can include all compounds which can improve the cold flow properties of the lubricating fluid, for example polymeric compounds. Examples of suitable pour point depressants include condensates of chlorinated paraffin and alkylnaphthalene, condensates of chlorinated paraffin and phenol, as well as polyalkylmethacrylates, polyalkylstyrenes, polybutenes, etc., which may also act as viscosity index improvers as mentioned above. In general, a lubricating fluid may include a single pour point depressant or a combination of two or more pour point depressants of the same or of different type.

The total amount of pour point depressant(s) present in the lubricating fluid can vary broadly. In general, pour point depressant(s) can be employed in amounts which can be effective to improve cold flow properties of a lubricating fluid. Effective amounts may range from 0.01 to 5.0%, from 0.05 to 5%, or from 0.1 to 3% by weight, based on the total weight of the lubricating fluid. The pour point depressant(s) may be added in larger amounts. However, larger amounts generally do not further improve the suitability of the lubricating fluid for spindle motors and may therefore be uneconomical. The pour point depressant(s) may also be added in smaller amounts so long as the amounts are effective to provide for the requisite cold flow properties.

Disclosed lubricating fluids can also optionally include anti-foaming agents. Suitable anti-foaming agents can include all compounds which can sufficiently suppress, prevent or diminish the tendency of bubble formation of the lubricating fluid. Examples of suitable anti-foaming agents include polysiloxanes, perfluoropolyethers, polyacrylates and similar organic polymers. In general, a lubricating fluid may include a single anti-foaming agent or a combination of two or more anti-foaming agents of the same or of different type.

The total amount of anti-foaming agent(s) present in the lubricating fluid can vary broadly. In general, anti-foaming agent(s) can be employed in amounts which can be effective to sufficiently suppress, prevent or diminish the tendency of bubble formation of the lubricating fluid. Effective amounts may range from 0.01 to 5%, from 0.05 to 5%, or from 0.1 to 3% by weight, based on the total weight of the lubricating fluid. The anti-foaming agent(s) may be added in larger amounts. However, larger amounts generally do not further improve the suitability of the lubricating fluid for spindle motors and may therefore be uneconomical. The anti-foaming agent(s) may also be added in smaller amounts so long as the amounts are effective to sufficiently suppress, prevent or diminish the tendency of bubble formation of the lubricating fluid.

The lubricating fluid can generally have any desired viscosity. In embodiments, the lubricating fluid can have a viscosity of 15 cp to 80 cp at 0° C. In embodiments, the lubricating fluid can have a viscosity of 25 cp to 70 cp at 0° C. In embodiments, the lubricating fluid can have a viscosity of 25 cp to 60 cp at 0° C.

### EXAMPLES

Materials

The materials were obtained from the following suppliers and unless otherwise noted were used as received. 3-methyl-1,5-pentanediol di-n-undecanoate was synthesized using 1 part 3-methyl-1,5-pentanediol and 2 parts undecanoic acid (Sigma Aldrich, St. Louis, Mo.); the mixture was cleaned up and purified using known procedures. 3-methyl-1,5-pentane diol di-n-nonanoate was synthesized using 1 part 3-methyl-1,5-pentandiol and 2 parts nonanoic acid (Sigma Aldrich, St. Louis, Mo.); the mixture was cleaned up and purified using known procedures. IRGANOX® L 57, octylated/butylated diphenylamine; IRGACOR® L 12, succinic acid half ester; and IRGAMET® 39, a tolutriazole derivative were obtained from Ciba Holding, AG (Basel, Switzerland). Tetraphenyl resoercinol diphosphate, commercially available as Reofos-RDP® was obtained from Chemtura Corporation (West Lafayette, Ind.). SYN-O-AD® 8478 a butylated triaryl phosphate additive was obtained from ICL Industrial Products (St. Louis, Mo.). STAT-SAFE® 2500 (a combination of kerosene, o-xylene, dodecylbenzensulfonic acid, and solvent naphtha) was obtained from Innospec Specialty Chemicals, Chelshire, UK. EXPINN® 10 (a combination of heptane and dodecylbenzenesulfonic acid) was obtained from Innospec Specialty Chemicals, Chelshire, UK.

Comparative Composition 1 (CC1) included 3-methyl-1,5-pentane diol di-n-undecanoate (98.4% by weight), IRGANOX® L57 (1.0% by weight), SYN-O-AD® 8478 (0.5% by weight), IRGACOR® L12 (0.05% by weight), and IRGAMET® 39 (0.05% by weight). Compositions 1 (C1) and 2 (C2) included the components of CC1 and 100 ppm STAT-SAFE® 2500 (C1) and 300 ppm STAT-SAFE® 2500 (C2).

Comparative Composition 2 (CC2) included 3-methyl-1,5-pentane diol di-n-nonanoate (98.4% by weight), IRGANOX® L57 (1.0% by weight), Reofos-RDP® (0.5% by weight), IRGACOR® L12 (0.05% by weight), and IRGAMET® 39 (0.05% by weight). Compositions 3 (C3), 4 (C4), and 5 (C5) included the components of CC2 and 100 ppm STAT-SAFE® 2500 (C3), 500 ppm STAT-SAFE® 2500 (C4), and 500 ppm EXPINN® 10.

### Example 1

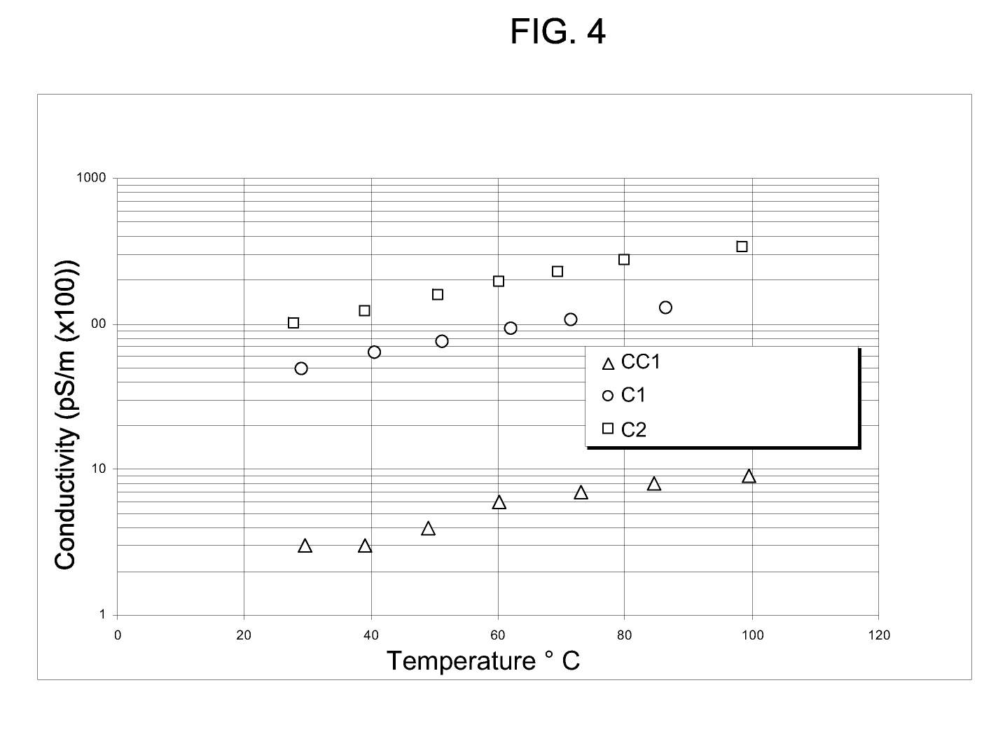

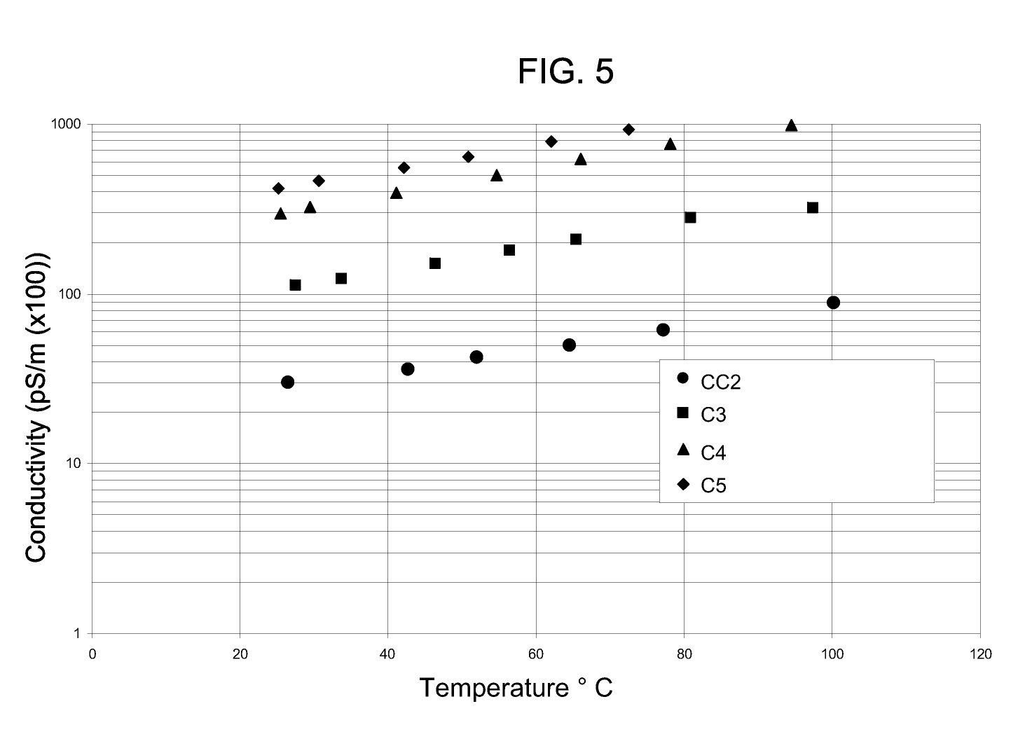

The conductivity of samples of CC1, C1, C2, CC2, C3, C4, and C5 were measured at temperatures ranging from 30° C. to 100° C. FIG. 4 shows the conductivity versus temperature for CC1, C1, and C2; and FIG. 5 shows the conductivity versus temperature for CC2, C3, C4, and C5.

### Example 2

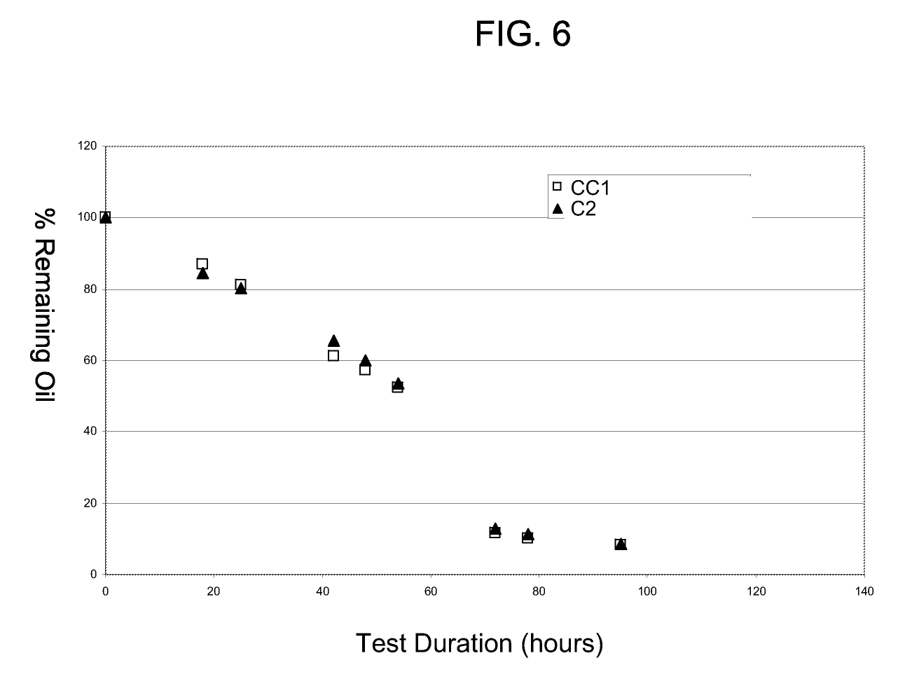

The evaporation of CC1 and C2 were monitored from 0 hours to 95 hours at 150° C. The percent of oil remaining as a function of time is reported in FIG. 6. As seen in FIG. 6, lubricating oil C2 that includes a disclosed conductivity inducing agent does not show an appreciable difference in evaporation rate when compared with the same oil without a conductivity inducing agent.

Thus, embodiments of HYDRODYNAMIC DISC DRIVE SPINDLE MOTORS HAVING HYDRO BEARING WITH LUBRICANT INCLUDING CONDUCTIVITY INDUCING AGENT are disclosed. One skilled in the art will appreciate that the present disclosure can be practiced with embodiments other than those disclosed. The disclosed embodiments are presented for purposes of illustration and not limitation, and the present disclosure is limited only by the claims that follow.

1. A spindle motor comprising:
a stationary member;
a rotatable member which is rotatable with respect to the stationary member; and
a hydro bearing interconnecting the stationary member and the rotatable member and having working surfaces separated by a lubricating fluid, wherein the lubricating fluid comprises:
a) a synthetic ester base fluid having a viscosity index of at least 110;
b) from 10 to 5000 ppm by weight, based on the total weight of the lubricating fluid, of at least one conductivity inducing agent
c) from 0.01% to 5%, by weight based on the total weight of the lubricating fluid, of at least one antioxidant; and
d) from 0.01% to 5% by weight, based on the total weight of the lubricating fluid, of at least one antiwear additive.

2. The spindle motor according to claim 1, wherein the synthetic ester base fluid comprises
compounds of formula I, 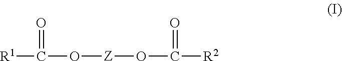
wherein R¹ and R² are identical or different and each represents a straight-chain C₃-C₁₇-alkyl group which optionally carries a C₁-C₃-alkyl bonded to a secondary carbon of the chain; and Z is a straight-chain C₃-C₁₀-alkylene group which optionally carries a C₁-C₃-alkyl bonded to a carbon of the chain;
compounds of formula Ia, 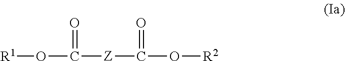
wherein R¹ and R² are identical or different and each represents a straight-chain C₃-C₁₇-alkyl group which optionally carries a C₁-C₃-alkyl bonded to a secondary carbon of the chain; and Z is a straight-chain C₃-C₁₀-alkylene group which optionally carries a C₁-C₃-alkyl bonded to a carbon of the chain;
or combinations thereof.

3. The spindle motor according to claim 1, wherein the at least one conductivity inducing agent is selected from:
a.) mixtures of chromium dialkyl salicylate and calcium didecyl sulfosuccinate in copolymers of lauryl methacrylate and methyl vinyl pyridine;
b.) compositions (in aromatic solvents for example) of a polymeric condensation product of N-tallow-1,3-diaminopropane and epichlorohydrin(3);
c.) compositions of 1-decene polysulfone and dicocodimethylammonium nitrite in toluene;
d.) colloidal solutions of alkylsalicylates, sulfonates, succinimides and other polar additives;
e.) magnesium oleate, the calcium salt of nitrate lube oil with stearic acid, compositions of chromium salts of C₁₇-C₂₀-synthetic fatty acids in toluene, chromium stearate, chromium salt long chain acids, chromium oleate, chromium linoleate, cobalt naphthenate, copper naphthenate, nickel naphthenate, diethylamine, 2-methylpyridine, pyridine, 3-methylpyridine, 2-amino-5-nitropyridine, and 2,6-dinitro-3-chloropyridine;
f.) stearylanthranylic;
g.) conducting polyaniline derivatives made soluble with long chain organic acid or hydrocarbon side chains;
h.) metal ion containing fullerenes; and
i.) metal ions

4. The spindle motor according to claim 1, wherein the conductivity inducing agent comprises a polymeric compound.

5. The spindle motor according to claim 4, wherein the polymeric compound comprises polyaniline.

6. The spindle motor according to claim 5, wherein the polymeric compound is represented by formula I: 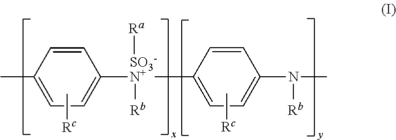
wherein 0<x/y<1; and
R^{a}, and R^{b} are each independently hydrogen or a hydrocarbon group; and
and R^{c} is a hydrogen, a hydrocarbon group, a halogen atom, or a hydrocarbon group that is bonded to the phenyl ring via oxygen or sulfur.

7. The spindle motor according to claim 1, wherein the conductivity inducing agent comprises R^{a}—SO₃H, wherein R^{a} is hydrogen or a hydrocarbon group.

8. The spindle motor according to claim 7, wherein the conductivity inducing agent is selected from the group consisting of: phenylsulfonic acids in which the phenyl ring optionally carries one, two or three identical or different straight chain or branched chain C₆-C₂₀-alkyl groups; straight or branched heptyl-phenyl sulfonic acid; straight or branched octyl-phenyl sulfonic acid; straight or branched nonyl-phenyl sulfonic acid; straight or branched decyl-phenyl sulfonic acid; straight or branched undecyl-phenyl sulfonic acid; straight or branched dodecyl-phenyl sulfonic acid; straight or branched tridecyl-phenyl sulfonic acid; straight or branched tetradecyl-phenyl sulfonic acid; straight or branched pentadecyl-phenyl sulfonic acid; straight or branched hexadecyl-phenyl sulfonic acid; straight or branched heptadecyl-phenyl sulfonic acid; straight or branched octadecyl-phenyl sulfonic acid; straight or branched nonadecyl-phenyl sulfonic acid; straight or branched decadecyl-phenyl sulfonic acid; straight or branched mono- or dihexyl-naphthyl sulfonic acid; straight or branched mono- or diheptyl-naphthyl sulfonic acid; straight or branched mono- or dioctyl-naphthyl sulfonic acid; straight or branched mono- or dinonyl-naphthyl sulfonic acid; straight or branched mono- or didecyl-naphthyl sulfonic acid; straight or branched mono- or diundecyl-naphthyl sulfonic acid; straight or branched mono- or didodecyl-naphthyl sulfonic acid; straight or branched mono- or ditridecyl-naphthyl sulfonic acid; straight or branched mono- or ditetradecyl-naphthyl sulfonic acid; straight or branched mono- or dipentadecyl-naphthyl sulfonic acid; straight or branched mono- or dihexadecyl-naphthyl sulfonic acid; straight or branched mono- or diheptadecyl-naphthyl sulfonic acid; straight or branched mono- or dioctadecyl-naphthyl sulfonic acid; straight or branched mono- or dinonadecyl-naphthyl sulfonic acid; and straight or branched mono- or didecadecyl-naphthyl sulfonic acid.

9. The spindle motor according to claim 1, wherein the lubricating fluid has a viscosity of from 15 cp to 80 cp at 0° C.

10. The spindle motor according to claim 1, wherein the lubricating fluid comprises at least one amine based antioxidant.

11. The spindle motor according to claim 1, wherein the lubricating fluid comprises at least one amine based antioxidant and at least one phenol based antioxidant.

12. The spindle motor according to claim 1, wherein the lubricating fluid comprises from 0.01% to 5% by weight, based on the total weight of the synthetic ester base fluid, of at least one viscosity index modifier.

13. The spindle motor according to claim 1, wherein the lubricating fluid comprises from 0.01% to 5% by weight, based on the total weight of the synthetic ester base fluid, of at least one pour point depressant.

14. The spindle motor according to claim 1, wherein the lubricating fluid comprises from 0.01% to 5% by weight, based on the total weight of the synthetic ester base fluid, of at least one anti-foaming agent.

15. The spindle motor according to claim 1, wherein the lubricating fluid further comprises a polyalphaolefin base fluid.

16. The spindle motor according to claim 1, wherein the synthetic ester base fluid comprises 3-methyl-1,5-pentanediol di(n-hexanoate), 3-methyl-1,5-pentane-diol di(n-heptanoate), 3-methyl-1,5-pentanediol di(n-octanoate), 3-methyl-1,5-pentanediol di(n-nonanoate), and 3-methyl-1,5-pentanediol di(n-deaconate), 3-methyl-1,5-pentanediol di(n-undecanoate), 3-methyl-1,5-pentanediol di(n-dodecanoic), and 3-methyl-1,5-pentanediol di(n-tridecanoate), or combinations thereof.

17. A spindle motor comprising:
a stationary member;
a rotatable member which is rotatable with respect to the stationary member; and
a hydro bearing interconnecting the stationary member and the rotatable member and having working surfaces separated by a lubricating fluid, wherein the lubricating fluid comprises
a) a synthetic ester base fluid having a viscosity index of at least 110;
b) from 10 to 5000 ppm by weight, based on the total weight of the lubricating fluid, of one or more aryl sulfonic acid conductivity inducing agent;
c) from 0.1% to 5%, by weight based on the total weight of the lubricating fluid, of at least one phenol antioxidant, amine antioxidant or phenol and amine antioxidants; and
d) from 0.1% to 5% by weight, based on the total weight of the lubricating fluid, of at least one antiwear additive.

18. The spindle motor according to claim 17, wherein the lubricating fluid comprises from 50 to 1000 ppm of the at least one aryl sulfonic acid.

19. The spindle motor according to claim 17, wherein the at least one conductivity inducing agent comprises dodecylbenzensulfonic acid.

20. A lubricating fluid comprising:
a) a synthetic ester base fluid having a viscosity index of at least 110;
b) from 50 to 1000 ppm by weight, based on the total weight of the lubricating fluid, of one or more aryl sulfonic acid conductivity inducing agents;
c) from 0.01% to 5%, by weight based on the total weight of the lubricating fluid, of at least one phenol antioxidant, amine antioxidant or phenol and amine antioxidants; and
d) from 0.01% to 5% by weight, based on the total weight of the lubricating fluid, of at least one antiwear additive.
